(19) United States
(12) Patent Application Publication
(10) Pub. No.: US 2011/0127994 A1
(43) Pub. Date: Jun. 2, 2011

(54) MAGNETIC SENSOR MODULES THAT COUPLE TOGETHER FOR EXTENDED DISTANCE POSITION SENSING

(75) Inventors: ANTHONY DMYTRIW, DEKALB, IL (US); STEWART D. JOHNSON, STOCKTON, IL (US)

(73) Assignee: HONEYWELL INTERNATIONAL INC., MORRISTOWN, NJ (US)

(21) Appl. No.: 12/629,750

(22) Filed: Dec. 2, 2009

(51) Int. Cl. G01B 7/14

(52) U.S. Cl. 324/207.11

(57) ABSTRACT

A magnetoresistive (MR) sensor module includes a MR sensor array including a plurality of MR sensors/bridge circuits. A first group of bridge circuits has an output coupled to a first signal conditioning circuit and a second group of bridge circuits has an output coupled to a second signal conditioning circuit. A first electrical connector is coupled to one end of the module and a second electrical connector is coupled to its opposite end. The pins include a pin for providing signal coupling between adjacent modules and a Vsupply pin for coupling Vsupply to adjacent modules. Signals from the second signal conditioning circuit are coupled to the first signal conditioning circuit which determines a position of a magnetic target. The first signal conditioning circuit communicates the position to the controller which outputs a single sensor module signal that includes the position of the magnetic target.

### TECHNICAL FIELD

Disclosed embodiments are generally related to magnetoresistive (MR) position sensors.

### BACKGROUND

Position sensors can be utilized to electronically monitor the position or movement of a mechanical component. Position sensors generate data that may be expressed as an electrical signal that varies as the position of the mechanical component changes. Such position sensors are typically utilized in machines to sense or control the mechanical position of one entity with respect to another in an automated system. In most cases, it is advantageous for the sensor entity not to make contact with the entity being sensed in order to eliminate the effects of mechanical wear over time.

An MR array position sensor comprises multiple MR position sensor elements that can be implemented as a non-contact sensor. For example, magnetic position sensing using Anisotropic MR (AMR) sensors is becoming a popular method of implementing non-contacting location of motional objects. By affixing a magnet or sensor element to an angular or linear moving object with its complementary sensor or magnet stationary, the relative direction of the resulting magnetic field can be quantified electronically.

Being able to sense a long distance (e.g., more than 1 m) by non-contact sensing can be advantageous in a variety of applications. However, conventional MR sensors can only position sense about 0.2 m due to factors including, but not limited to, practical limits for printed circuit board (PCB) lengths, practical limits to plastic molds for the housing, and practical limits of end of the line (EOL) test and calibration equipment.

### SUMMARY

Disclosed embodiments described herein include packaged MR sensor modules that are adapted to be concatenated in a sequential order to form MR sensor systems that enable extended distance position sensing. The MR sensor modules have first and second ends and comprise a plurality of MR sensors/MR bridge circuits each comprising a plurality of MR elements. The MR sensors/MR bridge circuits are arranged in a sequential order (e.g., in a line or an arc). The MR sensors/MR bridge circuits comprise a first group of bridge circuits having at least one output coupled to a first signal conditioning circuit and at least a second group of bridge circuits having at least one output coupled to a second signal conditioning circuit. A first electrical connector comprising a plurality of pins is coupled to one of the ends of the MR sensor module and a second electrical connector comprising a plurality of pins is coupled to its opposite end.

The plurality of pins include at least one pin for providing signal coupling between adjacent MR sensor modules and a Vsupply pin for coupling a Vsupply to adjacent MR sensor modules. Signals from the second electronic signal conditioning circuit are coupled to the first signal conditioning circuit, wherein the first signal conditioning circuit determines a position of the magnetic target. The MR sensor modules include a controller, such as a microprocessor or microcontroller, wherein the first signal conditioning circuit communicates the position to the controller, and the controller outputs a single sensor module signal that includes the position of the magnetic target with a position resolution to identify which pair of MR sensors the magnetic target is over.

The MR sensor system comprises a plurality of MR sensor modules hooked in series by coupling the electrical connectors, wherein the MR sensor system senses the position of a magnetic target over the extended distance that is spanned by the plurality of MR sensor modules. Each of the MR sensor modules finds and tracks the magnetic target when the magnetic target is within the area occupied by the individual MR sensor module itself. When a MR sensor module finds the magnetic target, it sends the location of the magnetic target on a digital data bus, such as a CAN bus. The location information contains the relative distance of the magnetic target within the particular MR module and the address (or location) of the MR sensor module that found the magnetic target. The first MR sensor module in the sequential order of modules is referred to herein as the master MR module, which receives this information on the data bus and outputs the position of the magnetic target from anywhere within the entire MR sensor system.

### BRIEF DESCRIPTION OF THE DRAWINGS

FIG. 1A is a side view depiction of an extended distance MR sensor system that comprises a plurality of MR sensor modules that are electrically coupled to one another to operate as a single MR sensor system that provides a single system output signal that contains the location of the magnetic target, according to a disclosed embodiment.

FIG. 1B shows the MR sensor system shown in FIG. 1A in operation when a magnetic target is positioned over one of the MR sensor modules, according to a disclosed embodiment.

FIG. 2A is a block diagram depiction of an exemplary MR sensor module, according to a disclosed embodiment.

FIG. 2B is a high level schematic that corresponds to MR sensor module shown in FIG. 2A, and adds several additional exemplary design details, according to an embodiment of the invention.

FIG. 2C is a block diagram depiction of an exemplary extended distance MR sensor system that comprises four (4) MR sensor modules, that are based on the MR sensor module depicted in FIG. 2A, according to a disclosed embodiment.

FIGS. 3A and 3B collectively provide a flow diagram showing exemplary control communications between a master MR sensor module and one or more slave MR modules, according to an embodiment of the invention.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate the disclosed embodiments. Several aspects disclosed herein are described below with reference to example applications for illustration. It should be understood that numerous specific details, relationships, and methods are set forth to provide a full understanding of the disclosed embodiments and their equivalents. One having ordinary skill in the relevant art, however, will readily recognize that the disclosed embodiments can be practiced without one or more of the specific details or with other methods. In other instances, well-known structures or operations are not shown in detail to avoid obscuring aspects of the disclosed embodiments. Disclosed embodiments are not limited by the illustrated ordering of acts or events, as some acts may occur in different orders and/or concurrently with other acts or events. Furthermore, not all illustrated acts or events are required to implement a methodology in accordance with the disclosed embodiments of their equivalents.

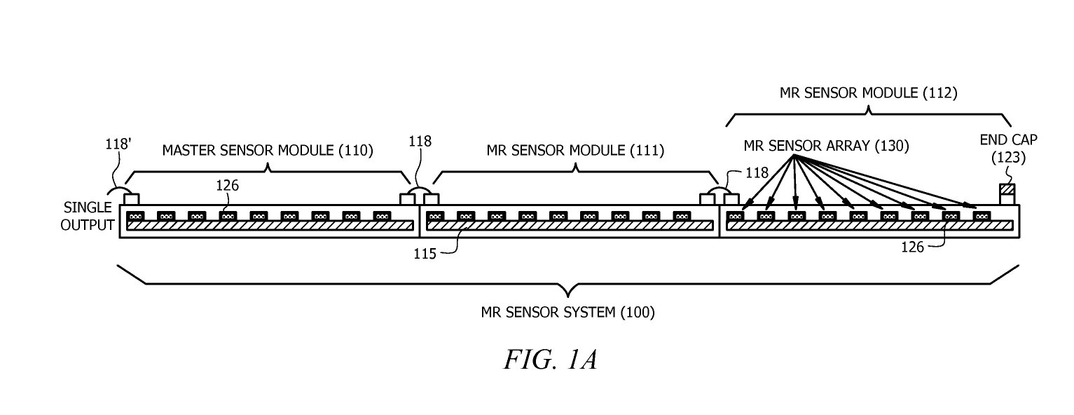

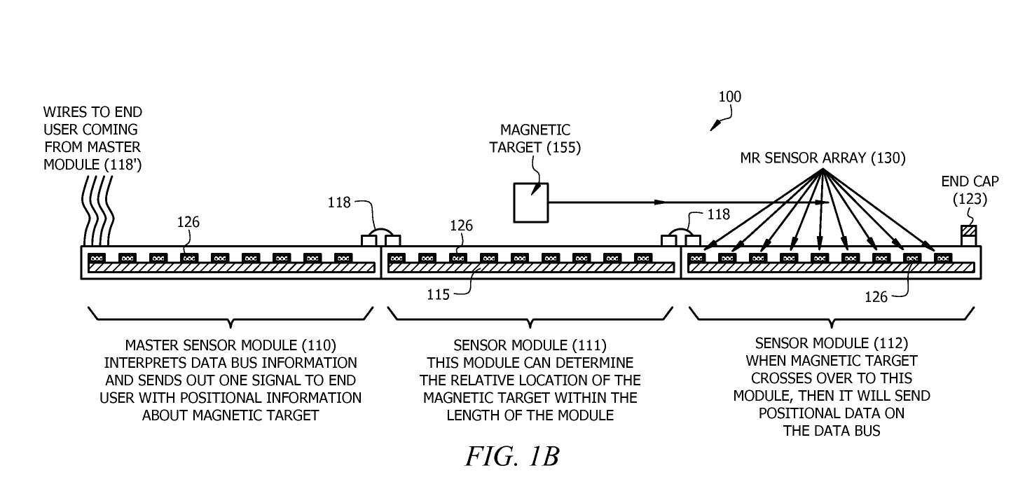

FIG. 1A is a side view high level depiction of an extended distance MR sensor system 100 that comprises a plurality of MR sensor modules 110, 111, 112 that are electrically coupled to one another to operate as a single MR sensor system, according to a disclosed embodiment. As described below, MR sensor system 100 provides a single system output signal that contains the location of the magnetic target.

In the arrangement shown, MR sensor module 110 is the master MR sensor module (hereafter master MR sensor module 110), while MR sensor modules 111 and 112 are slave MR sensor modules. The MR sensor modules 110, 111, 112 are identical, and the master MR sensor module 110 becomes the master sensor module solely by being the first on one end of the sequence of MR modules that has wires that are provided to a user, with the MR sensor module 112 on the other end of MR sensor system 100 generally unconnected and capped with an end cap 123. The MR sensor modules are connected to one another by electrical connectors 118 that generally comprise a plurality of pins that function as electrical jumpers.

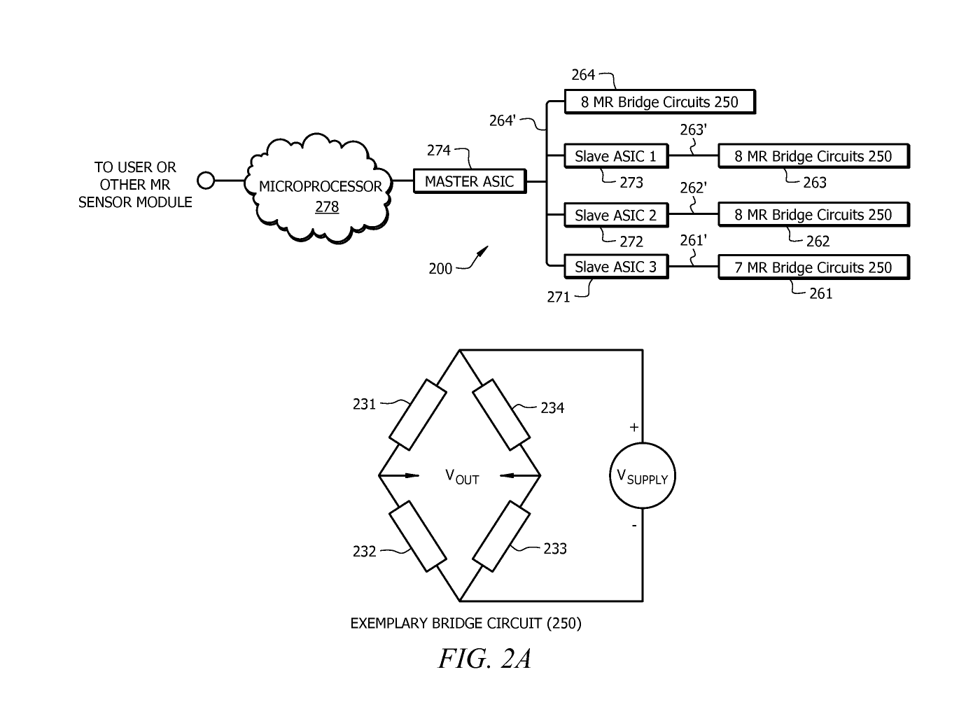

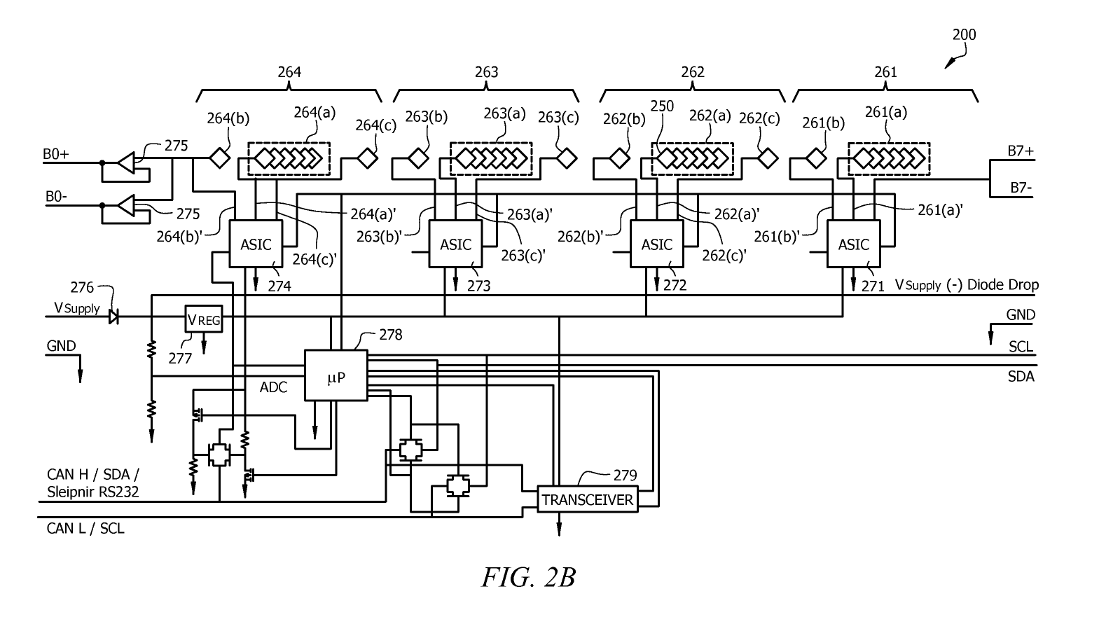

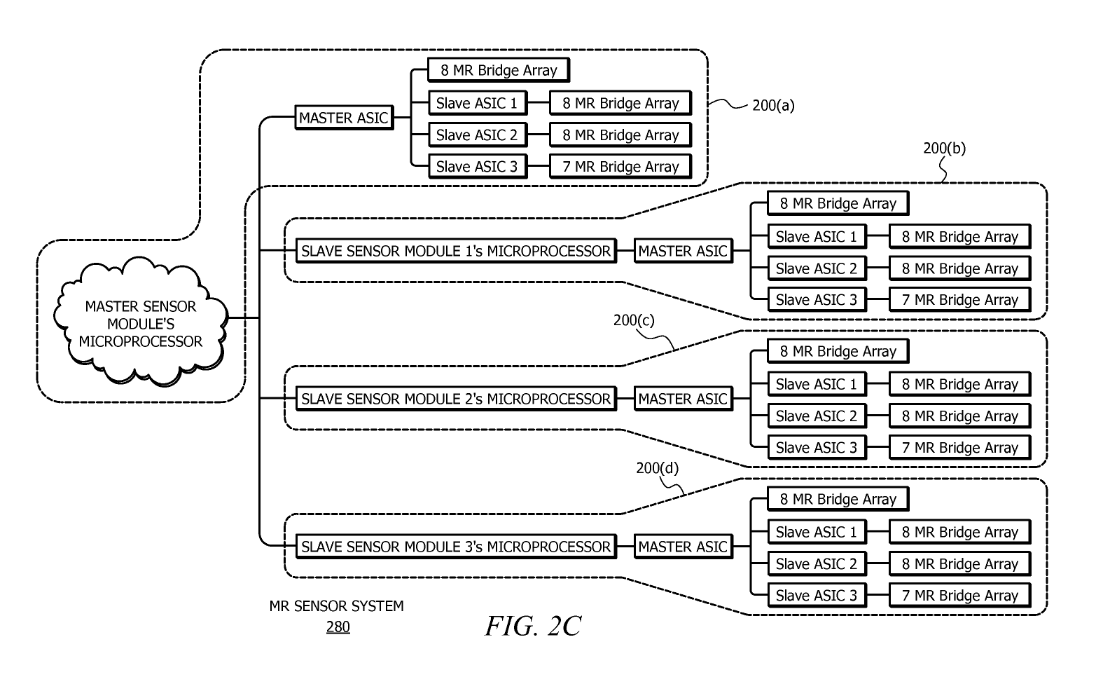

The MR sensor modules 110, 111, 112 each generally comprise a package substrate 115, such as a printed circuit board (PCB). MR sensor array 130 is shown and defined herein comprising all of the plurality MR sensors 126 in MR sensor system 100. For example, MR module 200 shown in FIG. 2A includes a 31 MR sensors. Each MR sensor 126 comprises a plurality of MR elements, typically 4 MR elements connected in a bridge configuration, so that MR sensors may also be referred to herein as bridge circuits. The MR sensors/bridge circuits 126 are arranged in a sequential order having first and second ends and as described below are grouped into a first group of bridge circuits that are coupled to a first signal conditioning circuit (e.g., ASIC) and at least a second group of bridge circuits that are coupled to a second signal conditioning circuit (the MR elements, and electronic signal conditioning circuits (e.g., ASICs) are not shown in FIG. 1A; see FIG. 2A).

Master MR sensor module 110 has its electrical connectors 118 on the end of the MR sensor system 100 occupied by master sensor module 110 shown as 118′. A single output for MR sensor system 100 is provided at electrical connector 118′ which also provide power to the MR sensor system 100. Electrical connector 118′ can comprise a wiring harness comprising a plurality of wires.

FIG. 1B shows MR system 100 shown in FIG. 1A in operation when a magnetic target 155 is positioned over MR sensor module 111, according to a disclosed embodiment. MR sensor module 111 can determine the relative location of the magnetic target 155 within the length of the MR sensor module 111 with a resolution to determine between which pair of MR sensors 126 the magnetic target 155 is over. MR sensor module 111 sends the positional data on a data bus, that is generally a digital data bus (e.g., CAN bus), to master MR sensor module 110. When the magnetic target 155 crosses over to MR sensor module 112, MR sensor module 112 will send positional data on the same data bus. The master MR module 110 interprets data bus information and sends out one signal to the end user with positional information about the magnetic target 155.

FIG. 2A is a block diagram depiction of an exemplary MR sensor module 200, according to a disclosed embodiment. MR sensor module 200 comprises a plurality of MR sensors/MR bridge circuits, with an exemplary bridge circuit 250 shown in FIG. 2A comprising a plurality of MR elements 231-234 interconnected to form a bridge circuit. MR sensor module 200 is shown having 31 bridge circuits.

The MR elements 231-234 in MR sensor/MR bridge circuit 250 in one embodiment comprise AMR elements. However, the MR elements can also generally comprise giant magneto-resistive (GMR), colossal magnetoresistive or tunneling magnetoresistive elements.

Four groups of bridge circuits/MR sensors 261-264 are shown in FIG. 2A. MR sensor module 200 is arranged to have a fixed number (say N) of MR bridge circuits for all but one of the groups of bridge circuits (groups 262, 263 and 264), with the last group of bridge circuits 261 in MR sensor module 200 having one less (N−1) MR sensor/bridge circuits. As described below relative to FIG. 2B, this asymmetry in number of bridge circuits along with suitable electrical coupling between adjacent MR sensor modules is design to eliminate ‘dead spots’ between MR sensor modules. As known in the art, such as disclosed in U.S. Pat. No. 6,097,183 to Goetz, et al. assigned to Honeywell International, the position of a magnetic target can be realized by processing sensing signals obtained from two adjacent MR sensors/MR bridges. In order to ensure a continuous positional signal across the full range of the linked together sensor modules including across the linkage area between MR modules, the first MR bridge/MR sensor signal of an MR module is shared between the MR module containing it and the preceding (upstream) MR module. This allows for a seamless transition as the magnet moves over one MR sensor module to another.

The fourth group of bridge circuits 261 has at least one output 261′ that is coupled to an electronic signal conditioning circuit shown as slave ASIC3 271. The first, second and third group of bridge circuits 262-264 have at least one respective output 262′, 263′, and 264′ that are coupled to a signal conditioning circuits slave ASIC2 272, slave ASIC1 273, and Master ASIC 274, respectively. Master ASIC 274 is shown coupled to microprocessor 278.

FIG. 2B is a high level schematic that corresponds to MR sensor module 200 shown in FIG. 2A, and adds several additional exemplary design details, according to a disclosed embodiment. The groups of bridge circuit groups 261-264 are shown comprising interior bridges 261(a)-264(a), respectively, and upstream end bridge 261(b)-264(b), with bridge circuit groups 262-264 including a downstream end bridge 262(c)-264(c). The interior bridges 261(a)-264(a) each provide a single output shown as 261(a)′-264(a)′, with the upstream end bridge 261(b)-264(b) providing outputs 261(b)′-264(b)′, with the downstream end bridge 262(c)-264(c) providing outputs 262(c)′-264(c)′, all such outputs coupled to their respective ASICs 271-274. As described above, this arrangement allows the first MR bridge/MR sensor signal of an MR module shown as 264(b) in FIG. 2B to be shared between the MR module containing it and the preceding (upstream) MR module for a seamless transition as the target magnet moves over one MR sensor module to another MR sensor module. For example, the signal from upstream end bridge 264(b) will be coupled (via buffers 275 coupling B0+ to B7+ and B0− to B7− as shown in FIG. 2B) to function as the downstream end bridge for bridge circuit group 261 of an adjacent MR module.

Voltage drop element 276 is shown as a forward biased diode for a Vsupply at a positive level, such as +24 volts. The voltage supplied to the MR sensor module after reduction by voltage drop element 276 is sampled after being voltage divided by an ADC provided by microprocessor (μP) 278. Voltage regulator (Vreg) 277 is also provided. Microprocessor 278 drives a digital protocol (e.g., CAN) transceiver 279 that is provided at the wires shown for coupling to another MR module or to a using when the MR sensor module is the master module. The output from Master ASIC includes data from slave ASICs 271, 272 and 273 is buffered by buffers 275.

MR sensor module 200 can be linked with other Sensor Modules to form an MR system such that one continuous signal can be achieved. Each Sensor Module in such a system can be calibrated by itself. Based on the voltage drop provided by voltage drop element, the order of sensor modules can be determined. The diode shown also provides reverse polarity protection. Pins labeled on left of this FIG. 2B from either customer interface or preceding sensor module. Pins labeled on right are either capped off or connected to next MR sensor module.

FIG. 2C is a block diagram depiction of an exemplary extended distance MR sensor system 280 that comprises four (4) MR sensor modules 200(a)-(d), that are based on MR sensor module 200 depicted in FIG. 2A, according to a disclosed embodiment. As shown, MR sensor module 200(a) is the master MR module, while MR sensor modules 200(b)-(d) are slave MR module 1, slave MR module 2, and slave MR module 3, respectively.

The ASICs can use a synchronous form of communication. MSD (master/slave data) and MSC is a typical way the ASICs can communicate amongst themselves to ultimately allow the master ASIC to output one positional signal based on where the magnetic target is within the full sensor module's sensing range.

In operation, multiple ASICs will communicate amongst themselves, if one ASIC finds the magnetic target, the master ASIC will then know of its location. The master ASIC then communicates this location to the microprocessor of the MR sensor module. The microprocessor communicates the location to master sensor MR module's microprocessor which outputs the complete location of the magnetic target.

For example, using the MR sensor system 280 arrangement shown in FIG. 2C, each MR sensor module includes 4 groups of MR sensors/MR bridges with the master and N−1 slave groups including 8 MR sensors/bridges that are each coupled to a common sensor group signal processing ASIC, with the Nth slave group including 7 MR sensors (more generally, one less MR sensor compared to the other bridge/sensor groups). There are thus 4 ASICs per module shown in FIG. 2C. The ASIC associated with MR sensor group 1 is referred to as the master ASIC, with the other ASICs (associated with sensor groups 2-4) are each referred to as slave ASICs 1-3.

In typical operation, the ASICs polls the MR sensor/MR bridge pairs (2 MR sensor/MR bridges at a time) until it finds the first instance where the differential voltage signal of the first bridge (called it bridge A) of the pair sampled is negative and the second bridge (call it bridge B) of the pair's differential voltage signal sampled is positive. The magnetic target is found between bridge pair AB. The ASIC takes the two signals (from bridges A and B) and can perform the following calculation:

(Signal_from_bridge_A−Signal_from_bridge_B)/Signal_from_bridge_A

This calculation yields the relative position of the magnetic target being in between bridges A and B. Other calculations can be used to increase accuracy can be performed on the relative position value calculated above.

For example, if the magnetic target is currently found between MR sensors 4 and 5 in MR sensor group 3/Slave ASIC 3 of Slave Sensor Module 2, Slave ASIC 3 would report the location of the magnetic target to the Master ASIC in Sensor Module 2. The master ASIC (in Sensor Module 2) would report the locational information to the Slave Sensor Module 2's Microprocessor. Then the Slave Sensor Module 2's Microprocessor would report the location to master sensor module's microprocessor. Finally, the master microprocessor would report the location of the magnetic target to the end user.

Each time the location information of the magnetic target gets reported up a level, more address information gets added (bridge addresses within ASIC, the ASIC address within sensor module, and sensor module's address within sensor system). This way when the final signal arrives at the end user, the information contains the accurate location of the magnetic target.

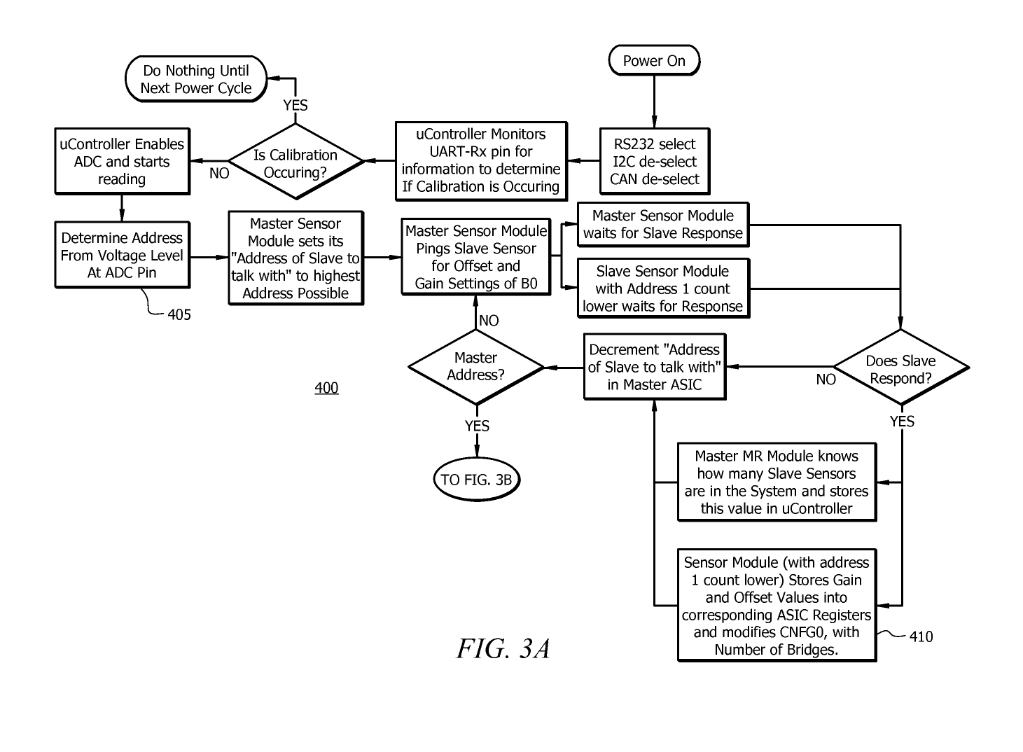

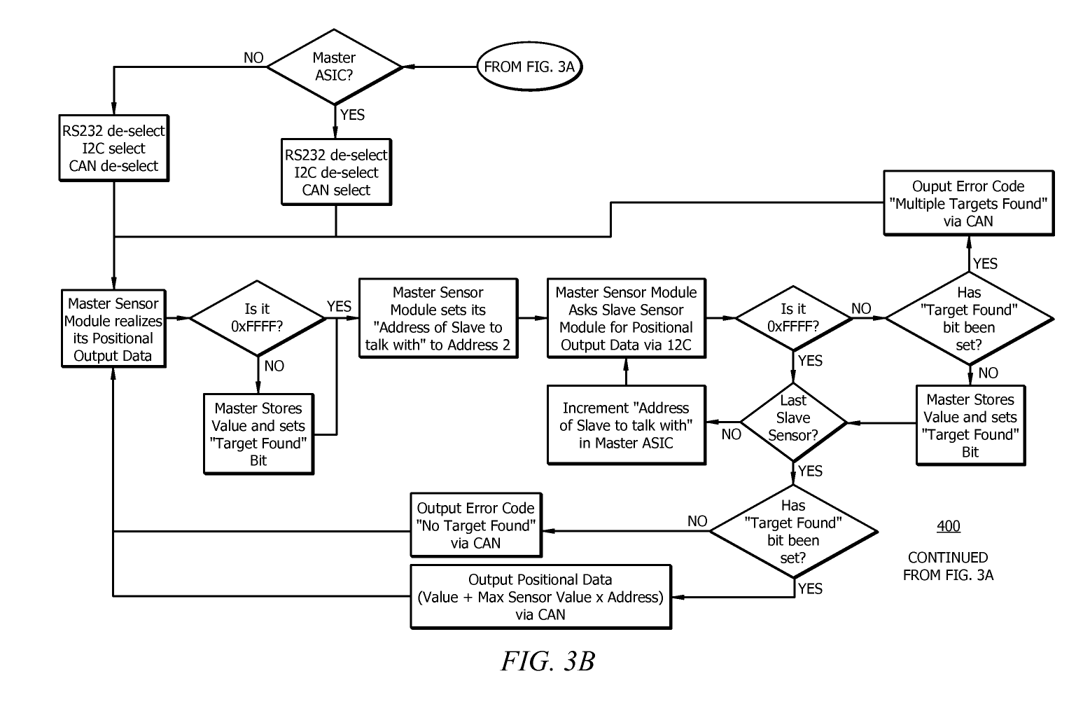

FIGS. 3A and 3B collectively provide a flow diagram 400 showing exemplary control communications between a master MR sensor module and one or more slave MR modules, according to an embodiment of the invention. Flow diagram 400 includes details for creating a long distance MR position sensor with which calibration of the sensor can be performed in several small steps. Box 405 is titled determining address from voltage level at ADC Pin. As described above, each sensor module in a system comprising a plurality of sensor modules will have a voltage drop element, such as a diode, in series with the Vsupply line. Since the supply line for the sensor modules is connected in series, the master sensor module (such as master sensor module 200(a) shown in FIG. 2C) will have the largest supply voltage and each Slave Sensor module will have a smaller supply voltage as compared to sensor before preceding it. As described above, a fraction (by voltage division) of the supply voltage feeds into the microcontroller's ADC to self-determine the sensor module's address in the system.

Box 410 is titled Sensor (with address 1 count lower) stores gain and offset values into corresponding ASIC registers, with number of bridges. The Microcontroller on each sensor module has the ability to put the Master ASIC in command mode and program values into its EEPROM. It is be able to pull down power on reset (POR) and then send 0x15 to enter command mode.

While various disclosed embodiments have been described above, it should be understood that they have been presented by way of example only, and not limitation. Numerous changes to the disclosed embodiments can be made in accordance with the disclosure herein without departing from the spirit or scope disclosed herein. Thus, the breadth and scope of the disclosed embodiments should not be limited by any of the above described embodiments. Rather, the scope of the disclosed embodiments should be defined in accordance with the following claims and their equivalents.

Although the disclosed embodiments has been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting disclosed embodiments or their equivalents. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which the disclosed embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A packaged magnetoresistive (MR) sensor module having first and second ends for determining a position of a magnetic target, comprising:
a MR sensor array on a package substrate, said MR sensor array comprising:
a plurality of MR sensors each comprising a plurality of MR elements in a sequential order and interconnected to form a plurality of bridge circuits, said array comprising a first group of said bridge circuits having at least one output coupled to a first signal conditioning circuit and at least a second group of said bridge circuits having at least one output coupled to a second signal conditioning circuit;
a first electrical connector comprising a plurality of pins coupled to said first end and a second electrical connector comprising said plurality of pins coupled to said second end, said plurality of pins including at least one pin for providing signal coupling between adjacent ones of said MR sensor modules and a Vsupply pin for coupling a Vsupply to said adjacent ones of said MR sensor modules;
wherein signals from said second signal conditioning circuit are coupled to said first signal conditioning circuit, and wherein said first signal conditioning circuit determines a position of said magnetic target, and
a controller, wherein said first signal conditioning circuit communicates said position to said controller, and said controller outputs a single sensor module signal that includes said position of said magnetic target with a position resolution to identify which of said plurality of MR sensors said magnetic target is over.

2. The MR sensor module of claim 1, wherein said MR sensor module includes a non-linear voltage drop element in series with said Vsupply pin.

3. The MR sensor module of claim 2, wherein said non-linear voltage drop element comprises a diode oriented to be forward biased.

4. The MR sensor module of claim 1, wherein said package substrate comprises a printed circuit board (PCB).

5. The MR sensor module of claim 2, wherein said controller comprises a microprocessor or microcontroller having an analog to digital converter (ADC) input, wherein said ADC input is coupled to sense said Vsupply after voltage level reduction by said non-linear voltage drop element.

6. The MR sensor module of claim 5, further comprising a digital protocol transceiver, wherein said controller provides a plurality of digital protocol outputs that are coupled to an input of said transceiver, and wherein said plurality of pins further comprises pins for communicating information received from said transceiver.

7. The MR sensor module of claim 1, wherein said first group of said bridge circuits consists of N of said bridge circuits, and said second group of said bridge circuits consists of N−1 of said bridge circuits.

8. The MR sensor module of claim 7, wherein:
said first group of said bridge circuits include a N−2 interior bridges interconnected to provide a first single interior bridge output, an first upstream end bridge providing a first upstream end bridge output and a first downstream end bridge providing a first downstream end output, wherein said first single interior bridge output, said first upstream end bridge output and said first downstream end output are coupled to said first signal conditioning circuit, and
wherein said second group of said bridge circuits include a N−2 interior bridges interconnected to provide a second single interior bridge output, a second upstream end bridge providing a second upstream end bridge output, wherein said second interior bridge output and said second upstream end bridge output are coupled to said second signal conditioning circuit.

9. The MR sensor module of claim 1 wherein said plurality of MR elements comprise AMR elements.

10. An MR sensor system, comprising
a plurality of series connected packaged MR sensor modules each having first and second ends comprising a first MR sensor module and at least a second MR sensor module electrically coupled to one another, said plurality of MR sensor modules each comprising a MR sensor array on a package substrate, said MR sensor array comprising:
a plurality of MR sensors each comprising a plurality of MR elements arranged in a sequential sensor order interconnected to form a plurality of bridge circuits, said array comprising a first group of said bridge circuits having at least one output coupled to a first signal conditioning circuit and at least a second group of said bridge circuits having at least one output coupled to a second signal conditioning circuit;
a first electric connector comprising a plurality of pins coupled to said first end and a second electrical connector comprising said plurality of pins coupled to said second end, said plurality of pins including at least one pin for providing said electrical coupling between said first and said second MR sensor module and a Vsupply pin for coupling a Vsupply to both said first and second MR sensor modules,
wherein signals from said second signal conditioning circuit are coupled to said first signal conditioning circuit, and wherein said first signal conditioning circuit determines a position of said magnetic target, and
a controller, wherein said first signal conditioning circuit communicates said position to said controller, and said controller outputs a single sensor module signal that includes said position of said magnetic target with a position resolution to identify which of said plurality of MR sensors said magnetic target is over;
wherein said first electrical connector of said first MR sensor module is coupled to said second electrical connector of said second MR sensor module to provide said series connection so that said first signal conditioning circuit of said second MR sensor module communicates said single sensor module signal to said controller of said first MR sensor module, and wherein said controller of said first MR sensor module generates a single system signal including a position of said magnetic target at said first electrical connector of said first MR sensor module.

11. The MR sensor system of claim 10, wherein said sensor module includes a non-linear voltage drop element in series with said Vsupply pin.

12. The MR sensor system of claim 11, wherein said non-linear voltage drop element comprises a diode oriented to be forward biased, wherein said system uses said Vsupply after reduction by said non-linear voltage drop element that is received at each of said plurality of MR sensor modules to determine a relative position of said plurality of MR sensor modules in said MR sensor system.

13. The MR sensor system of claim 10, wherein said package substrate comprises a printed circuit board (PCB).

14. The MR sensor system of claim 11, wherein said controller comprise a microprocessor or microcontroller having an analog to digital converter (ADC) input, wherein said ADC input is coupled to sense said Vsupply after reduction by said non-linear voltage drop element.

15. The MR sensor system of claim 10, wherein said plurality of MR sensor modules further comprise a digital protocol transceiver, wherein said controller provides a plurality of digital protocol outputs that are coupled to an input of said transceiver, and wherein said plurality of pins further comprises pins for communicating information received from said transceiver.

16. The MR sensor system of claim 10, wherein said first group of said bridge circuits consists of N of said bridge circuits, and said second group of said bridge circuits consists of N−1 of said bridge circuits.

17. The MR sensor system of claim 16,
wherein for each of said first and second MR modules:
(i) said first group of said bridge circuits include a N−2 interior bridges interconnected to provide a first single interior bridge output, an first upstream end bridge providing a first upstream end bridge output and a first downstream end bridge providing a first downstream end output, wherein said first single interior bridge output, said first upstream end bridge output and said first downstream end output are coupled to said first signal conditioning circuit, and
(ii) said second group of said bridge circuits include a N−2 interior bridges interconnected to provide a second single interior bridge output, a second upstream end bridge providing a second upstream end bridge output, wherein said second interior bridge output and said second upstream end bridge output are coupled to said second signal conditioning circuit, and
wherein said first upstream end bridge output of said second MR sensor module is coupled to an input of said second signal conditioning circuit of said first MR sensor module

18. The MR sensor module of claim 10, wherein said plurality of MR elements comprise AMR elements.
